(19) United States
(12) Patent Application Publication
(10) Pub. No.: US 2010/0072083 A1
(43) Pub. Date: Mar. 25, 2010

(54) Soap pouch and method for making

(76) Inventors: Beatrice M. Buffam, Wilton, CT (US); Ian D. Buffam, Washington, DC (US)

Correspondence Address: LITMAN LAW OFFICES, LTD., POST OFFICE BOX 41200, SOUTH STATION, ARLINGTON, VA, 22204, US

(21) Appl. No.: 12/585,613

(22) Filed: Sep. 18, 2009

Related U.S. Application Data
(60) Provisional application No. 61/136,681, filed on Sep. 24, 2008.

(51) Int. Cl. A47K 5/02; A47K 7/02; B65D 30/06; B65D 33/28; B23P 19/04

(52) U.S. Cl. 206/77.1; 15/208; 383/117; 383/72; 29/700

(57) ABSTRACT

The soap pouch is a double-layered net pouch adapted to enclose a bar of soap. The double-layered netting is fabricated from an extruded hydrophobic, thermoplastic, polymeric fiber. The netting has substantially smooth exterior surfaces and slip-fast meshes of an average width of one to twenty millimeters. The pouch is open at one end for easy replacement of soap. A drawstring is disposed at the open end for closing the open end when desired.

### CROSS-REFERENCE TO RELATED APPLICATION

This application claims the benefit of U.S. Provisional Patent Application Ser. No. 61/136,681, filed Sep. 24, 2008.

### BACKGROUND OF THE INVENTION

1. Field of the Invention

The present invention generally relates to toiletries, and more particularly to a soap pouch made from a mesh or net for containing a soap bar, soap balls, soap chunks, or other molded or solid forms of soap therein.

2. Description of the Related Art

The advent of the bathing puff, when showering or bathing, has rendered the use of the washcloth as old-fashioned. The bathing puff has many advantages including increased lathering and skin exfoliating abilities. However, puffs are best utilized with liquid soap and require constant lubrication of said liquid soap. Therefore, a liquid soap dispenser must be available for the user in the shower or tub. Many bathers and/or shower takers prefer using a soap bar. Unfortunately, producing lather by rubbing a bar of soap on a puff is very difficult and inefficient. Furthermore, the slippery soap is difficult to manipulate and often falls in the bath water or on the shower floor, resulting in frustrating, time-consuming retrieval efforts.

In the past it has been discovered that netting constructed of hard-elastic, thermoplastic high polymer, hydrophobic materials having slip-fast meshes of an average width of 1 to 20 millimeters was effective in creating lather when utilizing a soap bar. The disclosure and advantages of such netting is set out in U.S. Pat. No. 3,167,805, issued to Zuppinger et al., which is hereby incorporated by reference in its entirety. The above-cited patent uses netting to permanently encase a soap bar. It would certainly be advantageous if a bathing device could effectively and efficiently combine the advantages of the puff to improve the lathering and skin exfoliating abilities of the related art device when using a soap bar. Thus, a soap pouch solving the aforementioned problems is desired.

### SUMMARY OF THE INVENTION

The soap pouch comprises a double-layered pouch formed from netted material that is adapted to enclose a bar of soap. The double-layered net pouch is fabricated from an extruded hydrophobic, thermoplastic or polymeric fiber selected from the group consisting of polyethylene and polypropylene. The netting has substantially smooth exterior surfaces and slip-fast meshes of an average width of one to twenty millimeters. The pouch is open at one end for easy replacement of soap. A drawstring is disposed at the open end for closing the open end when desired.

Accordingly, the invention provides a soap pouch for enclosing a soap bar, wherein the pouch functions to increase the lathering properties of the soap bar. The pouch is also effective in exfoliating a user's skin. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a soap pouch according to the present invention.

FIG. 2 is a perspective view of a soap pouch according to the present invention with the outer net inverted and pulled away from the inner net to show details thereof.

FIG. 3 is a perspective view of a soap pouch according to the present invention, shown partially folded over.

FIG. 4 is an environmental elevation view in section of a soap pouch according to the present invention.

Similar reference characters denote corresponding features consistently throughout the attached drawings.

### DETAILED DESCRIPTION OF THE PREFERRED EMBODIMENTS

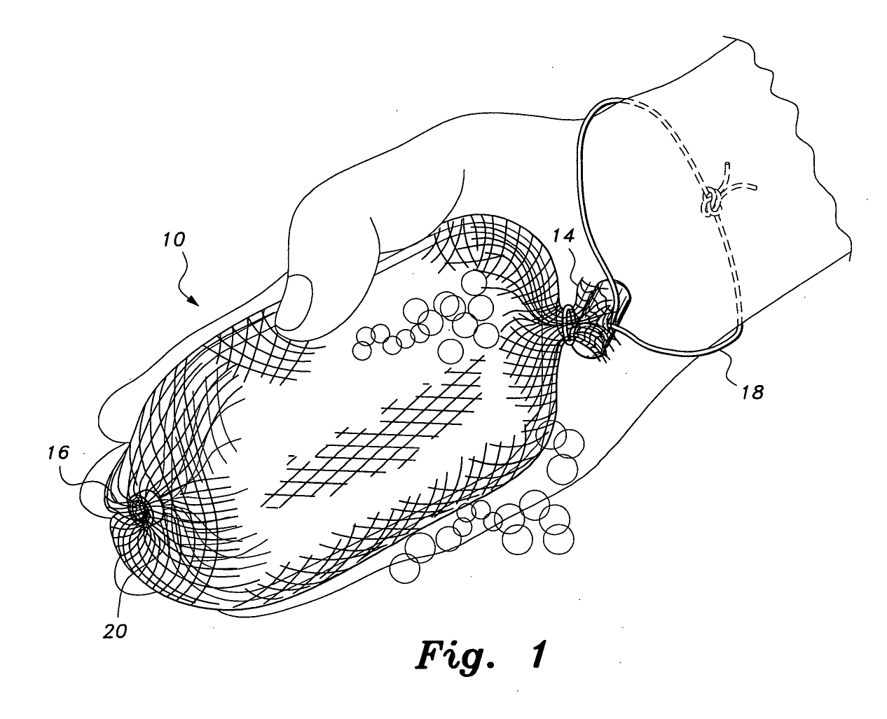

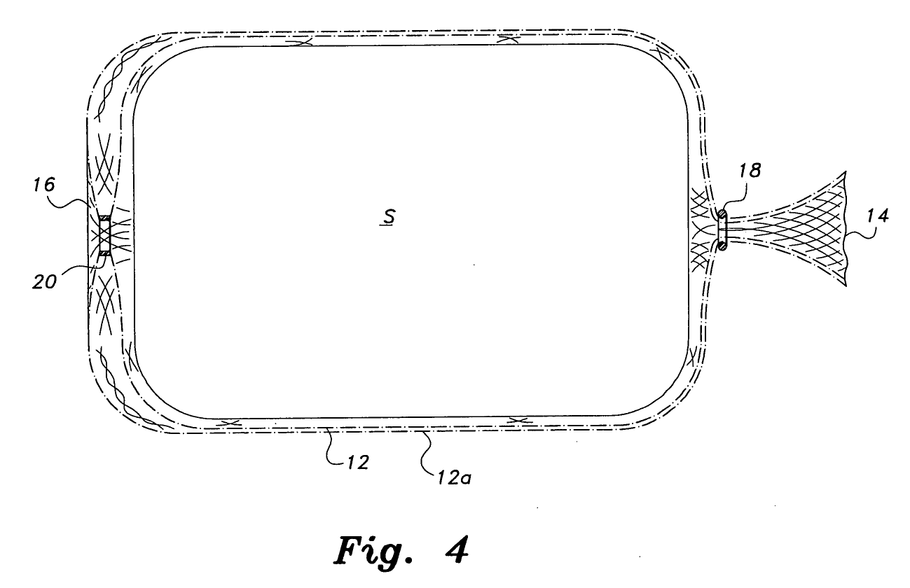

Referring to FIGS. 1 and 4, the soap pouch is generally indicated at 10. Pouch 10 comprises inner and outer layers of netting 12 and 12a, respectively, encasing a soap bar S. As used herein, the term “soap bar” refers to a bar of soap, soap balls, soap chunks, or any similar solid form of soap. Pouch 10 is open at its top end 14 and closed at its bottom end 16. A drawstring member 18 is threaded through the layers at the top end 14 and functions to selectively close the top end 14.

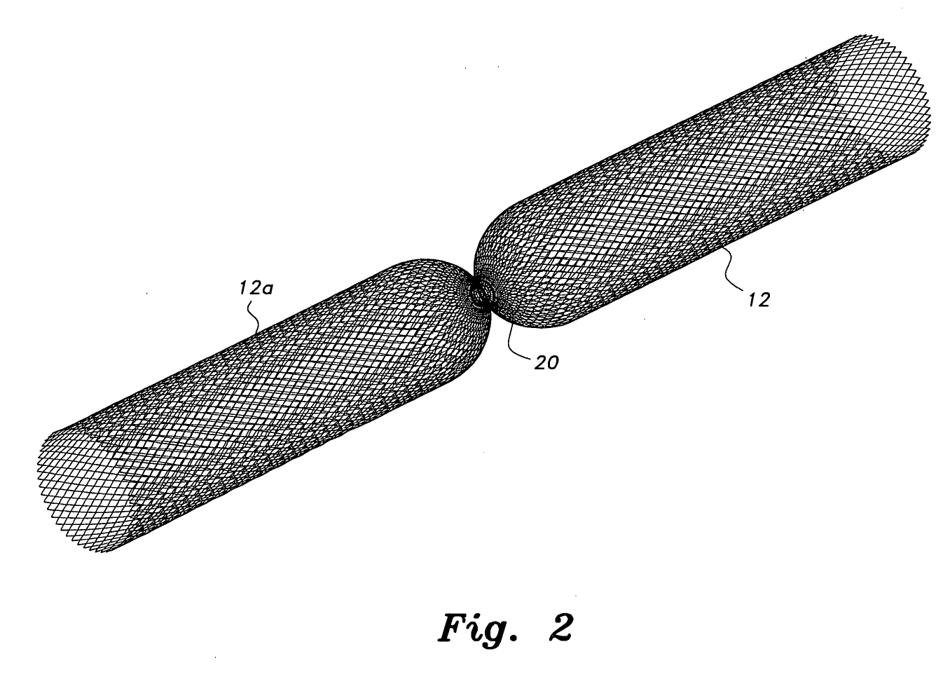

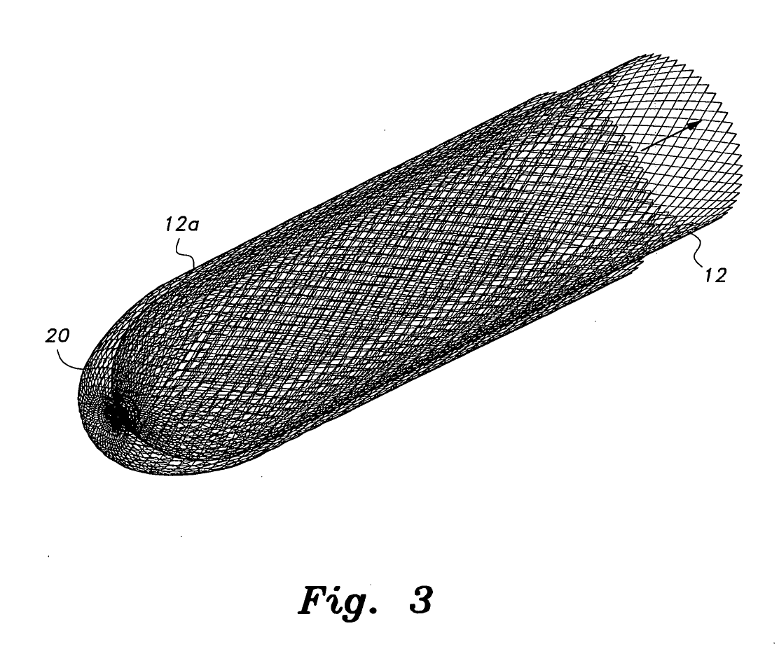

As best seen in FIGS. 2 and 3, the pouch 10 is fabricated from a single tube of netting. A band or ring member 20 is positioned approximately midway along the length of the tube to close the tube and define the inner layer 12 and outer layer 12a of the pouch 10. Outer layer 12a is folded over inner layer 12 to form the double-layered pouch 10.

As noted above, the pouch 10 is fabricated from an extruded hydrophobic, thermoplastic, polymeric fiber, such as polyethylene or polypropylene, and which may be high molecular weight or high density polyethylene or polypropylene. The netting has substantially smooth exterior surfaces and slip-fast meshes of an average width of one to twenty millimeters. The thread thickness of the netting is approximately 0.1 to two millimeters.

In use, a soap bar S or fragments thereof is inserted in pouch 10 through open top end 14. Drawstring 18 is manipulated to close the top end 14 and thereby enclose the soap bar S within the pouch 10. The pouch 10 and soap S are wetted with water, and the pouch 10 is rubbed against the user's skin. The double layers move independently of each other, causing increased lathering and exfoliating functions. If desired, the user can insert his/her hand through the drawstring loop 18 to keep the pouch 10 from falling away. The drawstring loop 18 can also be employed to hang the pouch 10 in a convenient location when not in use.

It is to be understood that the present invention is not limited to the embodiment described above, but encompasses any and all embodiments within the scope of the following claims.

We claim:

1. A soap pouch, comprising:
inner and outer layers of netting configured to form a double-layered pouch having an open top end and a closed bottom end, the netting being fabricated from a hydrophobic, thermoplastic, polymeric fiber having a substantially smooth exterior, the netting having slip-fast meshes of an average width of about 1 to 20 millimeters; and
a drawstring disposed around the open top for selectively closing the open top.

2. The soap pouch according to claim 1, wherein the fiber forming said netting has a thread thickness between about 0.1 to 2 millimeters.

3. The soap pouch according to claim 1, wherein said inner layer and said outer layer move independently of each other.

4. The soap pouch according to claim 1, further including a solid soap bar removably retained in said pouch.

5. A soap pouch, comprising:
inner and outer layers of netting configured to form a double-layered pouch having an open top end and a closed bottom end, the netting being fabricated from a hydrophobic, thermoplastic, polymeric fiber having a substantially smooth exterior, the netting having slip-fast meshes of an average width of about 1 to 20 millimeters, the fiber having a thread thickness between about 0.1 to 2 millimeters; and
a drawstring disposed around the open top for selectively closing the open top.

6. The soap pouch according to claim 5, wherein said inner layer and said outer layer move independently of each other.

7. The soap pouch according to claim 5, further including a solid soap bar removably retained in said pouch.

8. The soap pouch according to claim 5, wherein said fiber is selected from the group consisting of polyethylene and polypropylene.

9. A method of making a soap pouch, comprising the steps of:
providing a tube of netting material, the tube having a length, the netting material being fabricated from a hydrophobic, thermoplastic, polymeric fiber having a substantially smooth exterior and having slip-fast meshes of an average width of about 1 to 20 millimeters, the fiber having a thread thickness between about 0.1 to 2 millimeters;
positioning a ring member approximately midway along the length of the tube to close the tube midway along the length of the tube, forming two tubular segments;
folding one of the two tubular segments over the other of the two tubular segments to form a pouch, the pouch having an open end and a closed end; and
inserting a draw at the open end to selectively close the open end.

10. The method of making a soap pouch according to claim 9, further comprising the step of inserting a solid soap bar in said pouch.
